(19) United States
(12) Patent Application Publication
(10) Pub. No.: US 2004/0102233 A1
(43) Pub. Date: May 27, 2004

(54) Video instant prize system

(76) Inventor: Jeffrey C. Ostler, Alpine, UT (US)

Correspondence Address: KIRTON & McCONKIE, Suite 1800, 60 East South Temple, Salt Lake City, UT, 84111, US

(21) Appl. No.: 10/305,517

(22) Filed: Nov. 26, 2002

(51) Int. Cl. A63F 13/00

(52) U.S. Cl. 463/7

(57) ABSTRACT

A video instant prize system having a console, a monitor mounted on the console, a touch-screen game displayable on the monitor, a plurality of prizes, a prize dispensing mechanism, and an electronic control system for controlling the video instant prize system.

### BACKGROUND

1. Field of the Invention

The present invention relates generally to methods and systems for providing an instant prize as a consequence of winning a video game. More particularly, the present invention relates to a touch-screen video game console having an instant gift prize delivering mechanism.

2. Background

There are several types of vending or arcade-type machines that provide a reward to the player or customer. Some of these machines incorporate video games that are controlled by physical manipulation of a device such as a joystick. Other machines incorporate games that test a player's physical skill by requiring the player to mechanically maneuver a device in order to obtain a prize. Exemplary prizes include items such as gumballs, soda cans, or stuffed animals.

Some machines reward the player with a ticket that is to be taken to a redemption counter where the player can trade a number of tickets for a prize. This prize redemption system is not cost-effective because a redemption counter needs to be built, and employees for manning the counter need to be hired. Moreover, potential players may be discouraged from using the machine because of the extra time and hassle it takes to retrieve the prize.

Some types of article-dispensing machines operate as merchandising or vending machines whereby a customer inserts coins or other forms of payment into the machine; in return, the machine dispenses an item to the customer. Various items can be dispensed, including food, video game cartridges or disks, and CD's. Some of these vending machines include special measuring means that allow for volumetric measuring and dispensing of bulk items such as flour or bulk candy.

Various types of prize dispensers exist in the art. Among these include a horizontally oriented dispensing wheel that is commonly used to dispense rounded articles such as gumballs or capsules enclosing prizes. This horizontal dispensing wheel is often located below a hopper of the rounded articles/prizes. In some machines, when a person or customer twists a handle external to the gumball machine, a mechanical connection to the latter horizontal dispensing wheel causes the dispensing wheel to rotate in the horizontal plane. At a certain point in the rotation, the dispensing wheel is oriented so that a rounded article/prize is allowed to drop through a hole in the dispensing wheel for distribution to the customer.

### SUMMARY AND OBJECTS OF THE INVENTION

The present invention may be characterized generally as a video instant prize system having a console, a monitor mounted on the console, a touch-screen game displayable on the monitor, a plurality of prizes, a prize dispensing mechanism, and an electronic control system for controlling the video instant prize system.

Various touch-screen games may be incorporated into the present invention. Various dispensing mechanisms may be used as well. Exemplary dispensing mechanisms include an agitating chute system having a vertical agitator column and a series of fixed, slanted channels; a horizontal dispensing wheel; a worm device; and a hooked carousel.

The present invention is advantageous in that it provides an instant prize to players who win a touch-screen game.

Accordingly, it is an object of some embodiments of the present invention to provide instant delivery of a prize in response to a player's winning of a touch-screen game.

Another object of some embodiments of the present invention is to provide a video-based skill game wherein a player is instantly delivered a tangible prize.

A further object of some embodiments of the present invention is to provide a touch-screen game wherein prizes are dispensed by a vertically movable chute and horizontally movable capsule transport.

Another object of some embodiments of the present invention is to provide a touch-screen skill game wherein a player is dispensed an encapsulated prize via a vertically movable delivery chute and a horizontally movable capsule transport.

Yet another object of some embodiments of the present invention is to provide a touch-screen skill game wherein a player is dispensed a gift prize via a horizontal delivery wheel.

Another object of some embodiments of the present invention is to provide a touch-screen skill game wherein a player is dispensed a gift prize via a rotating worm device.

A further object of some embodiments of the present invention is to provide a touch-screen skill game wherein a player is dispensed a gift prize via a hooked carousel.

These and other objects and features of the present invention will become more fully apparent from the following description and drawings. Other objects will likewise become apparent from the practice of the invention as set forth hereafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIG. 1 is a front perspective view of one embodiment of the video instant prize system of the present invention.

FIG. 2 is a back view of the embodiment shown in FIG. 1.

FIG. 3 shows a representative display of a touch screen in accordance with one embodiment of the present invention.

FIG. 4 shows another display of a touch screen in accordance with one embodiment of the present invention.

FIG. 5 shows yet another display of a touch screen in accordance with one embodiment of the present invention.

FIG. 6 shows another display of a touch screen in accordance with one embodiment of the present invention.

FIG. 7 shows another display of a touch screen in accordance with one embodiment of the present invention.

FIG. 8 is a perspective view of one embodiment of a dispensing mechanism wherein the delivery chute of the dispensing mechanism is in a lowered position, and the capsule transport of the dispensing mechanism is in resting position.

FIG. 9 is a perspective view of the embodiment in FIG. 8 wherein the delivery chute is in a raised position and the capsule transport is in a forward position.

FIG. 10 is a perspective view of the embodiment in FIG. 8 wherein the delivery chute system is placed in a partially-assembled, open console.

FIG. 11 shows the embodiment of FIG. 8 shown from an inside angle.

FIG. 12 shows a back plan view of the embodiment of FIG. 8.

FIG. 13 shows a prize dispensing mechanism in accordance with one embodiment of the present invention.

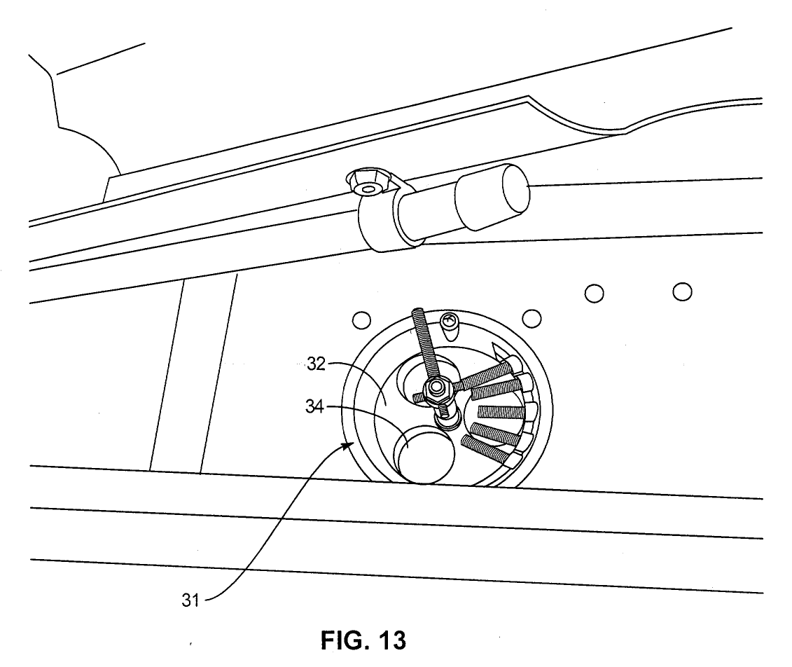

FIG. 14 shows another embodiment of a prize dispensing mechanism.

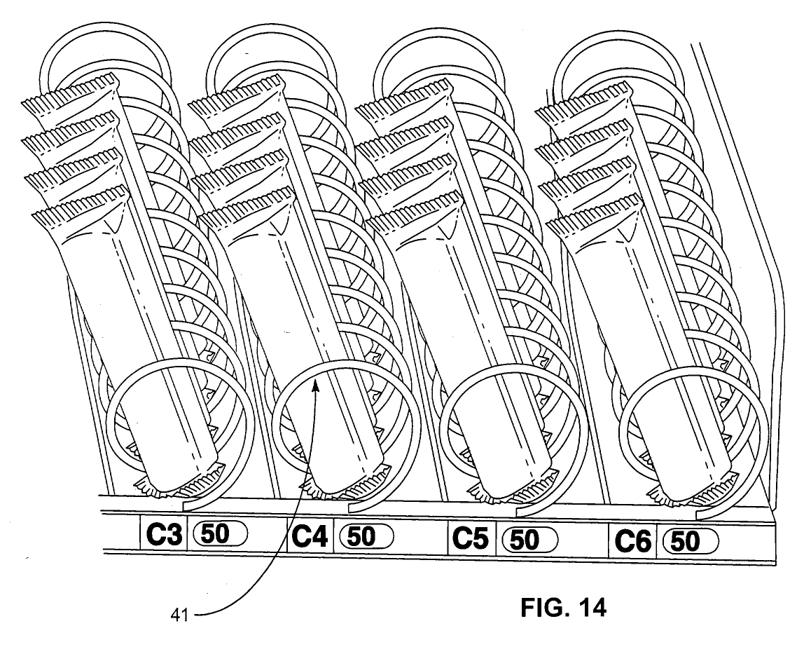

FIG. 15 shows yet another embodiment of a prize dispensing mechanism.

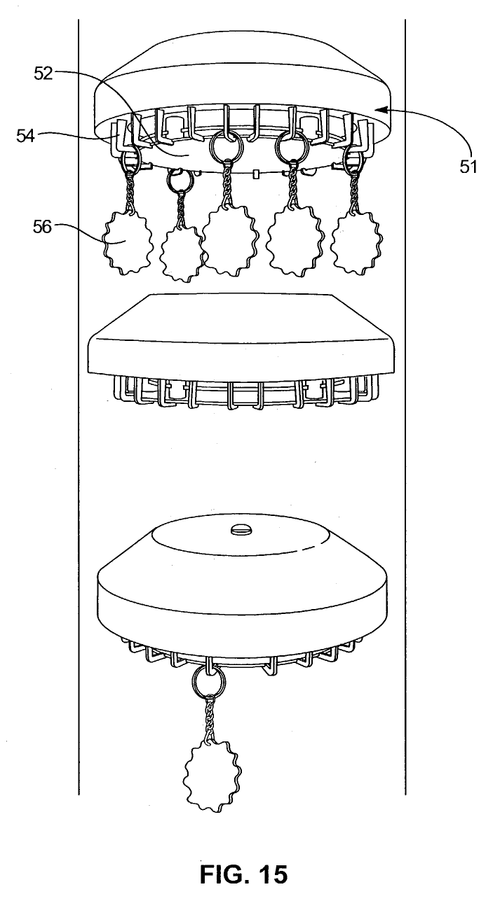

### DETAILED DESCRIPTION OF EMBODIMENTS OF THE PRESENT INVENTION

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

A purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The drawings and detailed description are merely representative of particular embodiments of the present invention.

Reference will now be made in detail to several embodiments of the invention. The various embodiments will be described in conjunction with the accompanying drawings wherein like elements are designated by like alphanumeric characters throughout.

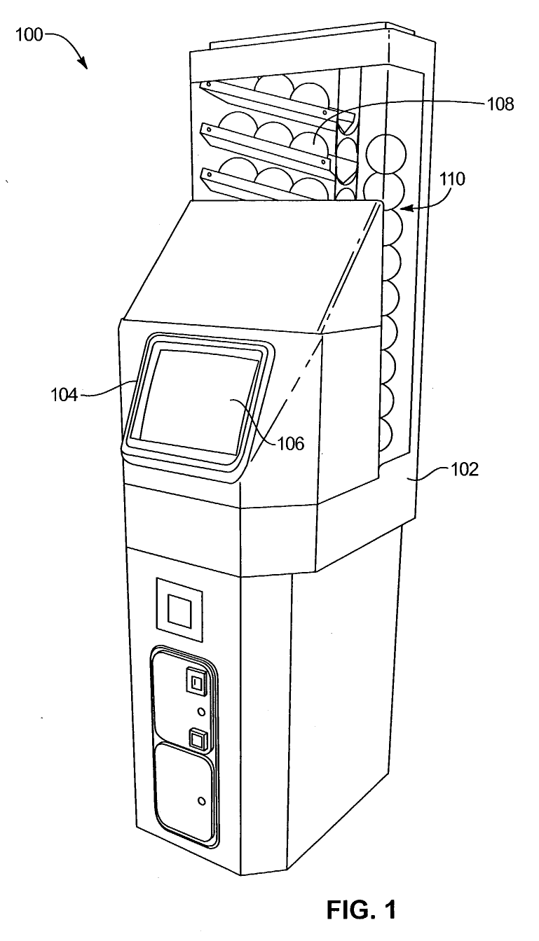

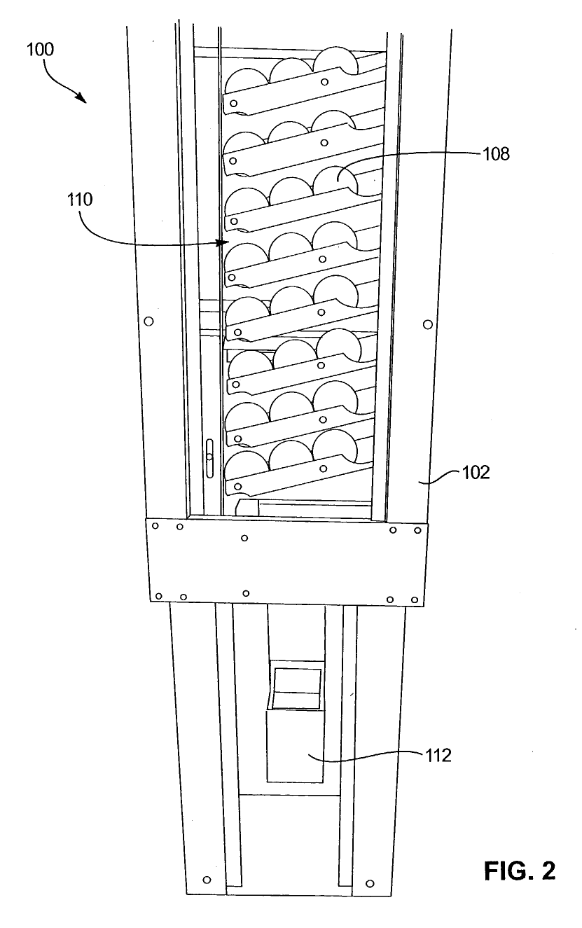

With reference now to the accompanying drawings, FIG. 1 shows a front perspective view of a video instant prize system 100 in accordance with one embodiment of the present invention. The video instant prize system 100 basically comprises a console 102, a monitor 104 mounted on the console 102, a touch-screen game 106 displayable on the monitor 104, a prize 108, a dispensing mechanism 110, and an electronic control system 112 (the latter shown in FIG. 2).

The console 102 is preferably stand-alone; however, it can also be designed to sit on a tabletop. In the preferred embodiments, the console 102 is suited for use in public areas (as opposed to use adapted to a personal computer) such as in a video arcade, the lobby of a movie theater, or in a grocery store lobby. The monitor 104 can be any sort of monitor suitable for use as a touch screen.

The touch-screen game 106 is displayed on the monitor 104 and is preferably a game involving metal skill—as opposed to a gambling game based on pure luck wherein the odds of winning are typically pre-programmable. The touch-screen game 106 is also preferably solely a video game wherein the player or customer does not manipulate a physical control such as a joystick; instead, the player interacts solely with the console 102 by touching the screen of the monitor 104. However, the touch-screen game 106 can be any sort of game appropriate for use with a touch screen such as a card game or a game that requires answering trivia questions.

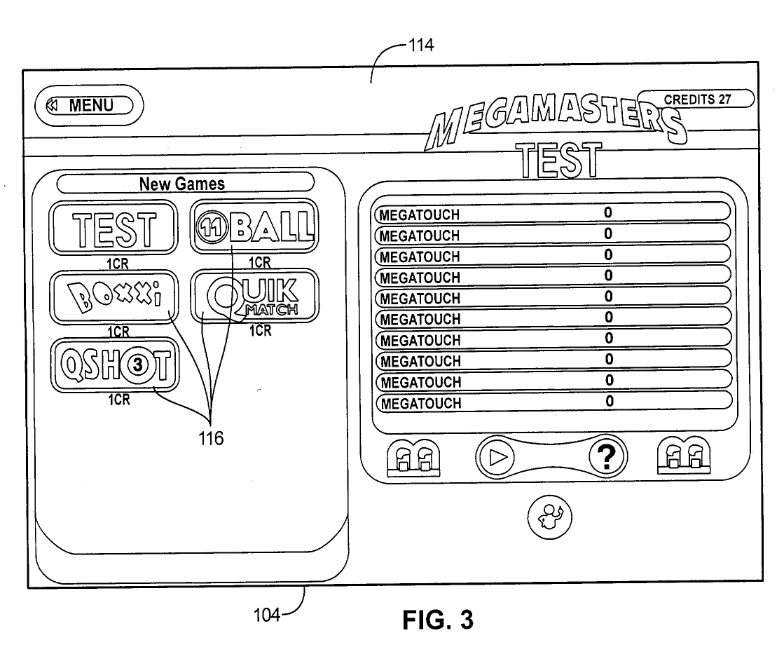

Multiple touch-screen games 106 can be incorporated into the video instant prize system 100 of the present invention. For example, in FIG. 3, an exemplary electronic screen 114 is shown. This electronic screen 114 provides a menu of several electronic buttons 116 that allow a player to choose what video game he or she desires to play.

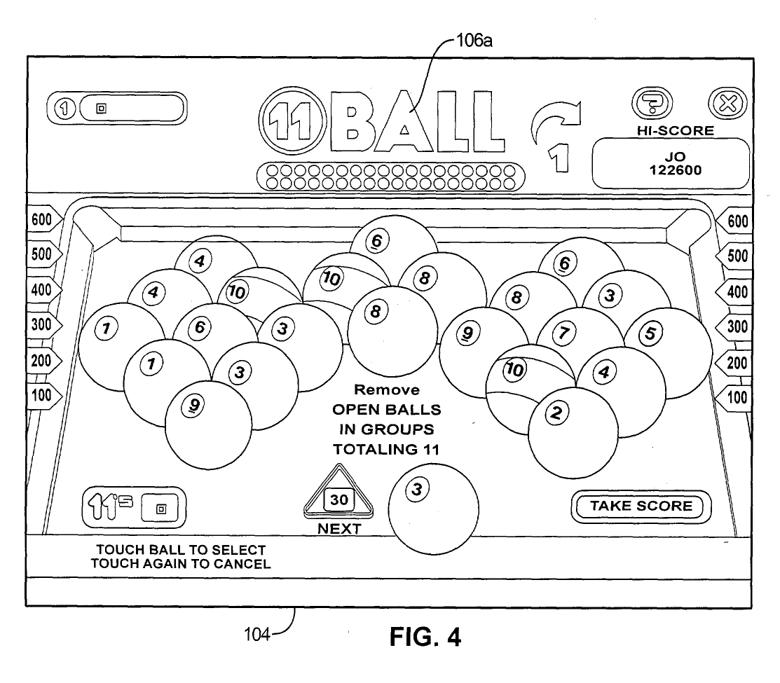

FIGS. 4 through 7 show four examples of touch-screen games 106 that might be incorporated into the present invention. Each of these particular examples represents, respectively, games well known in the industry and marketed by Merit Industries, Inc. under the marks 11 BALL, BOXXI, QUICK MATCH, and QSHOT.

FIG. 4 shows an electronic screen 106a displayed at the start of the 11 BALL game. When playing the 11 BALL game, the player tries to get rid of the billiard balls as fast as possible by choosing sets of balls having numbers that add up to the number eleven.

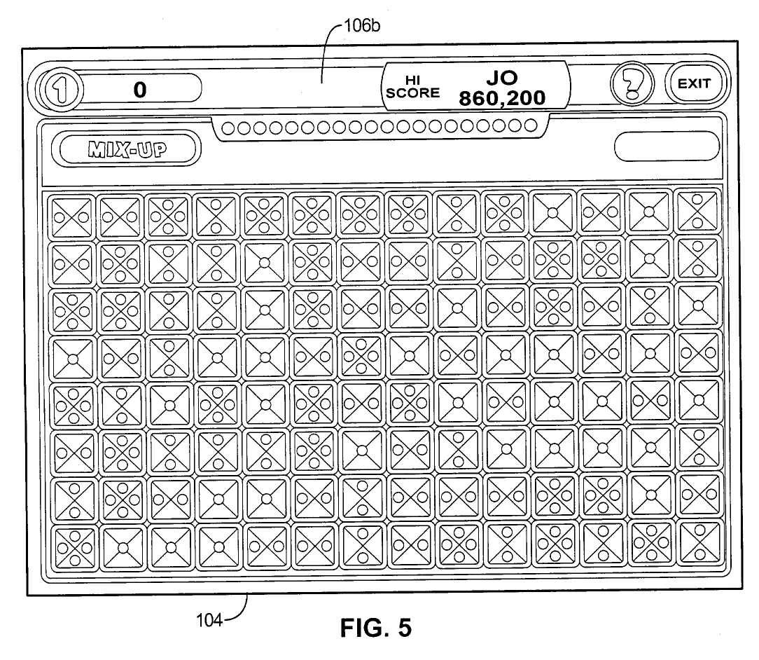

FIG. 5 shows an electronic screen 106b displayed at the start of the BOXXI game. When playing the BOXXI game, the player tries to get rid of the blocks as fast as possible by choosing groups of adjacent blocks that all have the same color.

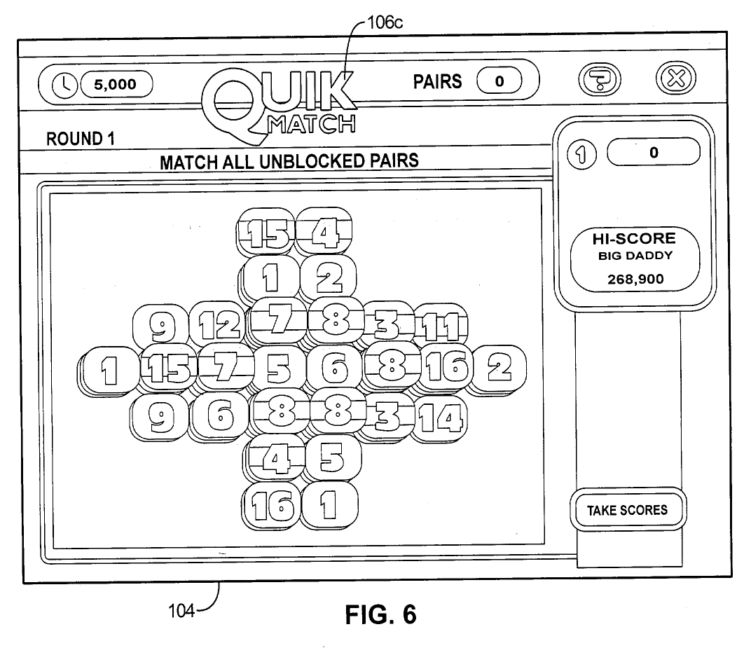

FIG. 6 shows an electronic screen 106c displayed at the start of the QUICK MATCH game. When playing the QUICK MATCH game, the player tries to get rid of the squares as fast as possible by matching pairs of unblocked squares.

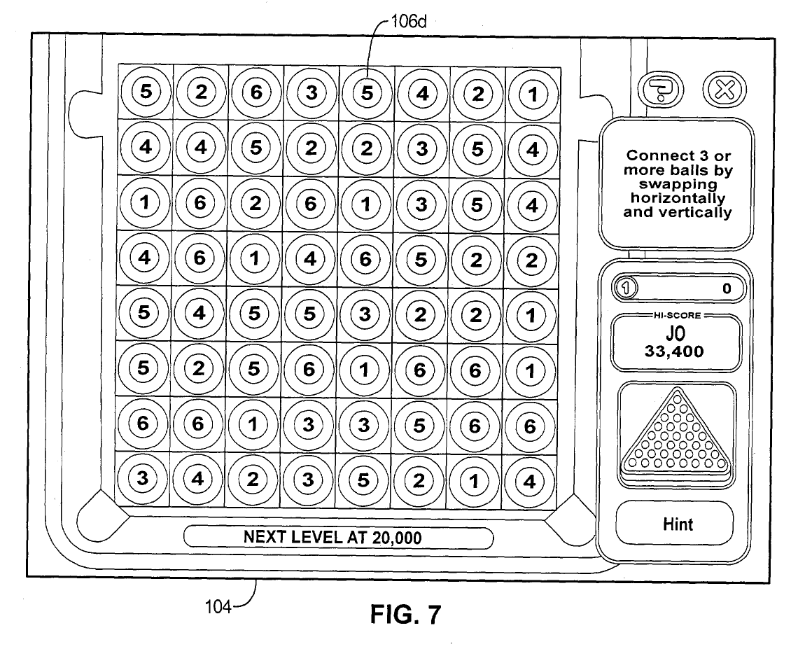

FIG. 7 shows an electronic screen 106d displayed at the start of the QSHOT game. When playing the QSHOT game, the player tries to get rid of the balls as fast as possible by horizontally and vertically swapping the balls so that they form a row of at least three of more identical balls.

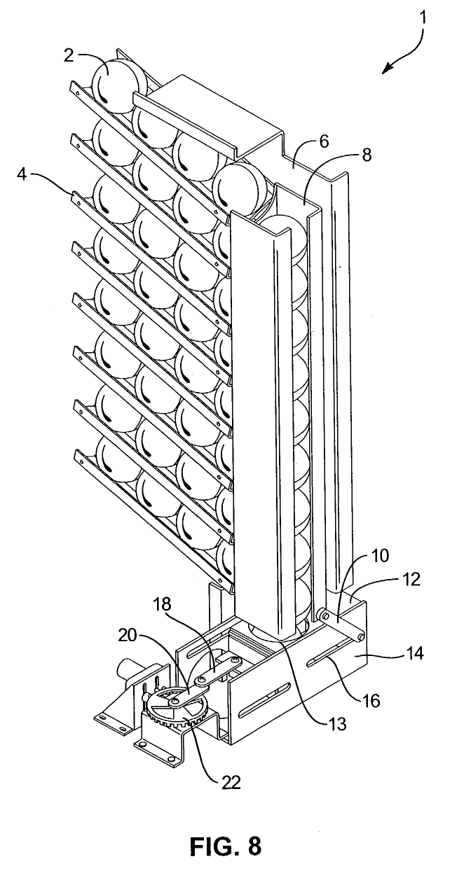

Various types of prizes 108 may be used in the present invention. Prizes 108 are actual tangible “gift prizes”—as opposed to money, tickets, or coupons that the player must redeem in order to obtain a tangible gift. Prizes 108 may include items such as stuffed or plastic toys, candy, gumballs, or disks such as DVD's or audio CD's. Furthermore, the prizes 108 can be enclosed by capsules 2 (shown, for example, in FIG. 8). The capsules 2 are preferably plastic hollow spheres that are about four inches in diameter. It should be noted that multiple types of prizes 108 corresponding to multiple score levels may be used. For example, a video instant prize system 100 might have two types of prizes: a “small prize” and a “large prize”; when the player obtains a certain minimum score, the player will receive a small prize, and when the player obtains a certain higher minimum score, the player will receive a large prize.

The dispensing mechanism 110 may be embodied in various forms, some specific forms of which will be described further herein. The electronic control system 112 comprises a motherboard and other computer elements used to operate and connect the touch-screen game 106, the monitor 104, the prize dispensing mechanism 110, and any other electronic component of the video instant prize system 100.

To operate the video instant prize system 100, the player or customer inserts a token in an electronic token slot on the console 102 (tokens may include coins, arcade game tokens, bills, credit cards, or the like). This signals the electronic control system 112 to display a menu on the monitor 104. The player may then touch the screen of the monitor 104 to start a touch-screen game 106. When the player reaches a certain score, the electronic control system 112 activates an electronic switch (not shown) in the console 102. The electronic switch activates the prize dispensing mechanism 110 which then instantly dispenses a prize 108.

Various dispensing mechanisms 110 may be used in the present invention. However, four embodiments will be discussed below.

FIG. 8 is a perspective view of one embodiment (also shown in FIGS. 1 and 2) of a dispensing mechanism of the present invention. In particular, shown is an agitating chute system 1 that can be found in machines marketed by O.K. Manufacturing, LLC of Salt Lake City, Utah under the mark GRAVITY HILL. In this agitating chute system 1, several capsules 2 are stored in slanting channels 4 that are preferably fixed to a back panel 6 and are adjacent to one side of a delivery chute or agitator column 8. As was mentioned earlier, the capsules 2 can enclose a variety of prizes, including stuffed or plastic toys, candy, or gumballs. In the preferred embodiments, the capsules 2 are transparent, hollow, plastic, substantially spherical, and about four inches in diameter.

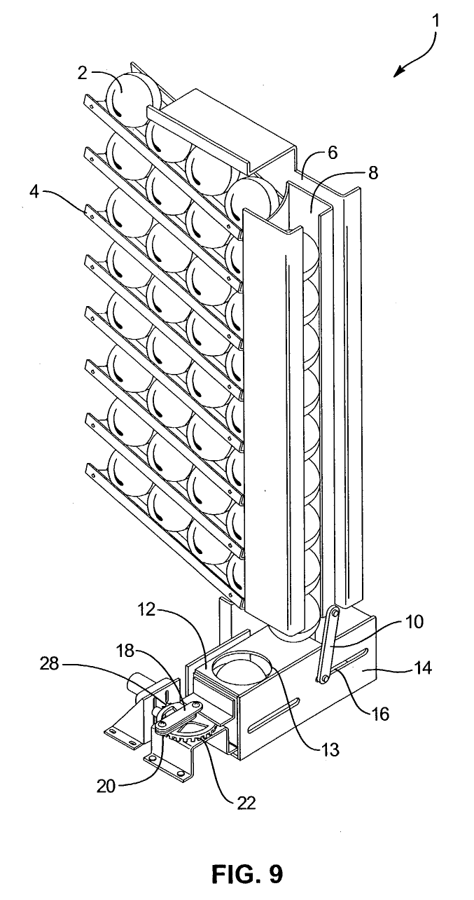

Gravity causes the capsules 2 in the slanting channels 4 to fall naturally towards the delivery chute 8. The delivery chute 8 is movable, preferably in a substantially vertical direction, with respect to the back panel 6 and the slanting channels 4. The delivery chute 8 is open at the bottom so that capsules 2 contained therein naturally drop (that is, they are pulled by gravity) downward into a hole 13 (shown more clearly in FIG. 9) in the top of a capsule transport 12 when the capsule transport 12 is positioned so that the hole 13 is directly below the bottom opening of the delivery chute 8. The capsule transport 12 is movable, along a stationary transport guide 14, within a plane substantially perpendicular to the longitudinal plane of the delivery chute 8.

In the preferred embodiments, the capsule transport 12 is attached to the delivery chute 8 via a pivot bar 10 which is pivotally connected to the delivery chute 8. With respect to the connection of the pivot bar 10 to the capsule transport 12, the pivot bar 10 is fixedly attached to the capsule transport 12 so that the connection slides along an elongated slot 16 in the transport guide 14 when the capsule transport 12 moves along the transport guide 14.

Also, in the preferred embodiments, the capsule transport 12 is attached to a transport bar 18, which transport bar 18 is pivotally attached to a disc bar 20, the latter disc bar 20 being fixedly attached to a substantially flat, horizontally rotatable disc 22. In the embodiment depicted in FIG. 8, the disc 22 is a cog wheel. However, the disc 22 need not be cogged.

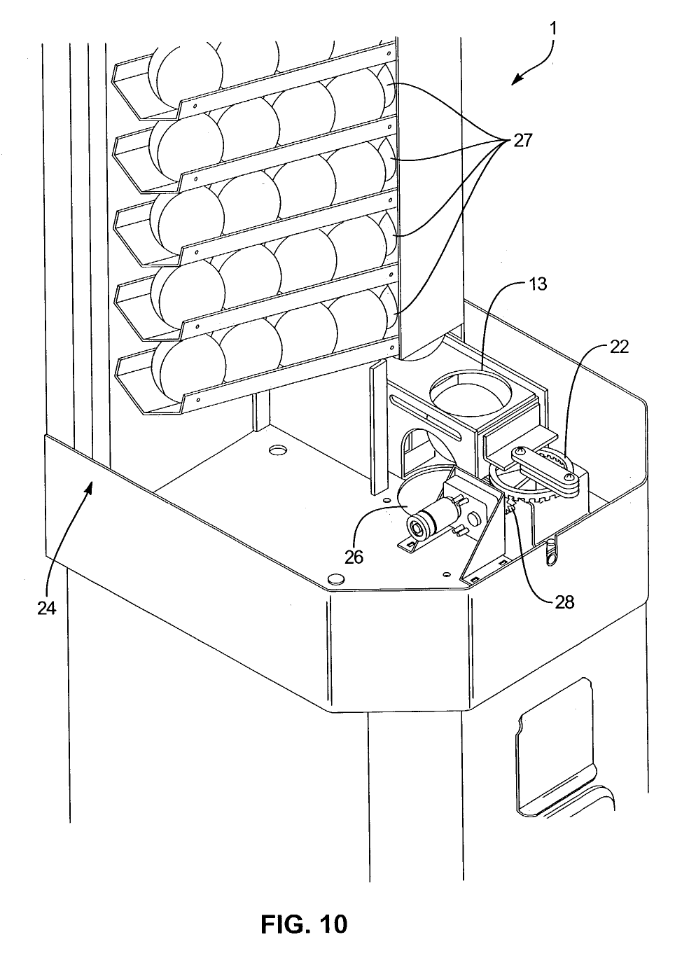

When a capsule 2 is to be delivered, an electronic switch causes the horizontal disc 22 to rotate in a substantially horizontal plane. In some embodiments (such as the embodiment shown in FIG. 10), the electronic switch activates a vertically oriented cog wheel 28 that connects with cogs on disc 22 to cause the latter disc 22 to rotate in the horizontal plane. Preferably, the electronic switch is located so as to avoid inadvertent destruction when a repair person works near the disc 22.

As disc 22 rotates, bar 20 correspondingly rotates and pulls bar 18 so that the capsule transport 12 moves forward from the delivery chute 8. When bar 20 has rotated to the point where it overlaps with bar 18, the capsule transport 12 is at its forwardmost position (shown in FIG. 9) where the capsule in the transport 12 then is lined up with and falls down a hole 26 (shown in FIG. 10 where the capsule is shown just before it is about to fall down the hole 26) in a vending or game console 24 for delivery. It is important to note that any sort of mechanism (as opposed to a disc and bar mechanism) can be used to move the transport 12. Such a mechanism would include, for example, a simple motor.

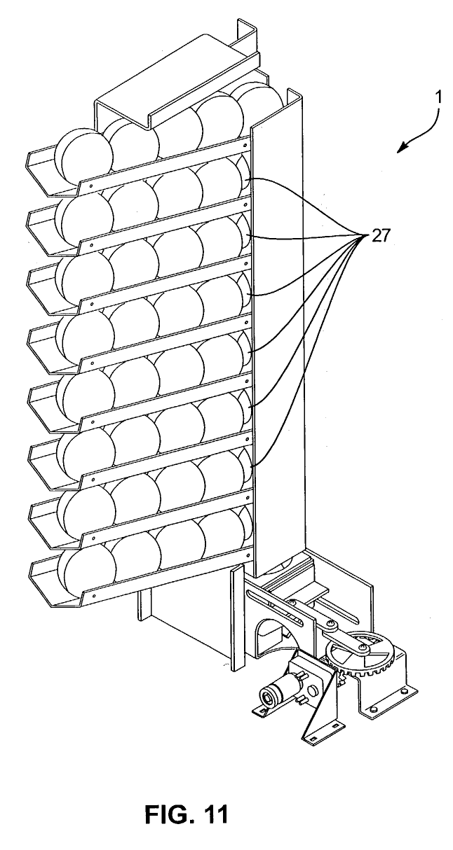

As can be seen by carefully comparing FIGS. 8 and 9, the delivery chute 8 is in a lowered resting position (which, for convenience, could also be referred to as a “first position”) in FIG. 8 and in a raised agitating position (which, for convenience, could be referred to as a “second position”) in FIG. 9. The side of the delivery chute 8 that is adjacent to the slanting channels 4 has holes 27 (best seen in FIG. 11) that are shaped to allow the capsules 2 in all but the topmost of the slanted channels 4 to abut the capsules 2 inside the delivery chute 8 when the delivery chute 8 is in its lowered resting position shown in FIG. 8. In other words, when the delivery chute 8 is in its first position, the capsules 2 in the slanting channels 4 are held back from entering the delivery chute 8 by the capsules 2 within the delivery chute 8.

When in its second position, the holes 27 of the delivery chute 8 block the capsules 2 in all of the slanting channels 4 except for the topmost of the channels 4 so that none of the next-in-line capsules 2 (that is, the capsules 2 adjacent to the delivery channel 8) in the lower channels 4 can enter the delivery chute 8. After the column of capsules 2 is agitated by movement into this second position, the topmost next-in-line capsule falls into the top of the delivery chute 8.

A comparison of FIGS. 8 and 9 shows that the pivot bar 10 of the preferred embodiments moves the delivery chute 8 vertically upward away from the transport 12 as the transport 12 moves forward. In other words, it can be seen that as the capsule transport 12 moves forward, the pivot bar or other suitable equivalent 10 causes the delivery chute 8 to agitate vertically upward to the second raised position so as to receive another capsule 2 in the topmost capsule queue.

As the disc 22 continues its rotation, the capsule transport 12 is moved back to its original position, and the pivot bar 10 also returns to its original position, causing the delivery chute 8 to lower and allow the bottommost capsule in the delivery chute 8 to fall into the hole 13 at the top of the capsule transport 12 in preparation for the next delivery. The agitation of the delivery chute 8 against a set of slanted parallel channels 4 provides several advantages over existing prize dispensing mechanisms. (Incidentally, it is immaterial whether the agitator column 8 is up while the transport 12 is resting or whether the column 8 is up while the transport 12 is in its forward position; likewise goes for when the agitator column 8 is down). For example, the parallel channel configuration distributes the weight of the round capsules 2 in such a way that minimizes breakage of the capsules 2; this is particularly important if the capsules 2 are made of fragile material. Also, the parallel channel configuration makes it easy to de-jam the system should the capsule flow become jammed; with the present invention, a repair person need only reach into a single slanted channel 4 wherein the jam is located (as opposed to having to redistribute all the capsules in an entire hopper full of capsules). Moreover, the configuration of the present invention maximizes the use of space by lining up the capsules 2 in a parallel configuration instead of wasting space by heaping capsules in a random order.

FIG. 11 shows the embodiment of FIG. 8 shown from an inside angle.

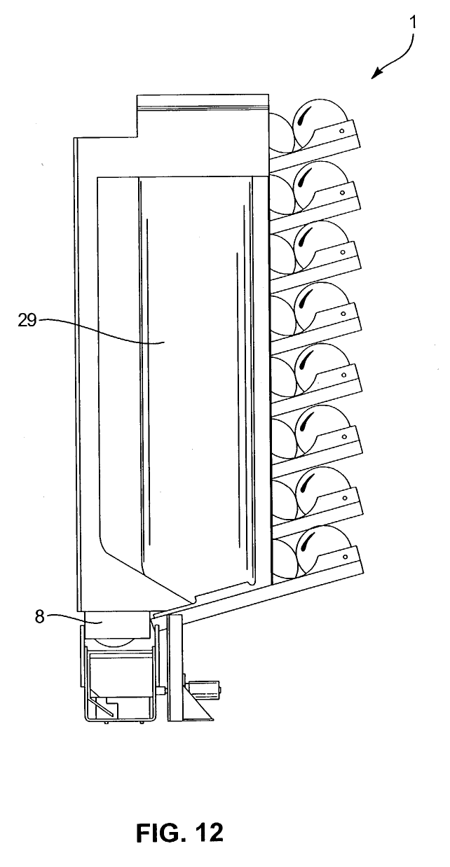

FIG. 12 shows a back plan view of the embodiment of FIG. 8. An optional small prize trough 29 is can be seen here. In some embodiments of the present invention, small prizes can be stored in a cavity (not shown) inside the console 24 (see FIG. 10) so that they can be dispensed through a horizontal delivery wheel (also not shown) in the console 24. In these embodiments, the trough 29 serves as additional storage for small prizes should the cavity not be large enough to accommodate a desirable number of small prizes.

Another type of dispensing mechanism includes a horizontal dispensing wheel 31. The horizontal dispensing wheel is a device commonly used in the art and comprises a flat disk 32 with one or more holes 34 in it through which the prize 108 may drop.

Another type of dispensing mechanism is also a device commonly used in the art. This device is also known as a “worm” device 41 and is frequently incorporated into vending machines. The worm 41 is a spiral-shaped piece that dispenses items when it is rotated.

Another type of dispensing mechanism is a hooked carousel 51. The carousel 51 comprises a disk 52 with multiple hooks 54 that carry prizes 56. In some embodiments, the disk 52 may rotate to dispense the prize 56 and subsequently release it from the hook 54. A machine marketed by a company called “Sammy” under the mark SPORTS ARENA incorporates one type of carousel 51.

It should be noted that the video instant prize system 100 of the present invention may incorporate multiple dispensing mechanisms 110 instead of simply one. Preferably, at least one of the dispensing mechanisms 110 is adapted to dispense capsules 2. It should also be noted that the system 110 can include various additional features, including sound effects, music, and a display to indicate a time limit as well as for displaying a counter indicating the number of plays available.

It is underscored that the present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. An apparatus comprising:
a console;
a monitor mounted on the console;
a touch-screen game displayable on the monitor;
a plurality of prizes;
a dispensing mechanism for dispensing said plurality of prizes; and
an electronic control system for controlling the touch-screen game and the dispensing mechanism.
